(19) United States
(12) Patent Application Publication
(10) Pub. No.: US 2007/0245577 A1
(43) Pub. Date: Oct. 25, 2007

(54) Pivot pencil

(76) Inventor: Gregory R. Ordaz, Las Vegas, NV (US)

Correspondence Address: Gregory R. Ordaz, 6509 Hyde Ave, Las Vegas, NV, 89107, US

(21) Appl. No.: 11/395,842

(22) Filed: Apr. 3, 2006

(51) Int. Cl. B43L 9/02

(52) U.S. Cl. 33/27.02

(57) ABSTRACT

The “Pivot Pencil” is a writing instrument: carpenters pencil, mechanical pencil, pen, marking pen, etc; A Pivot Swivel Joint inserted into the center of the Wooden Outer Casing that “allows the tool to pivot in various angles”, which allows the pencil access in tight spots and around corners. If you can't reach the surface you wish to mark, you might as well guess. But the “Pivot Pencil” can take away all the guesswork. The unique pivoting design is all the accuracy you need.

### BRIEF DESCRIPTION OF THE DRAWINGS

FIG. 1 is a perspective view showing the writing instrument and pivoting embodiment in use.

FIG. 2 is an orthogonal view of the top side of the writing instrument of FIG. 1.

FIG. 3A is an orthogonal sectional view of FIG. 2 at the initial position.

FIG. 3B is an orthogonal sectional view of FIG. 2 at a subsequent pivot position.

FIG. 4 is an orthogonal partial sectional view of the outer side of the writing instrument of FIG. 2.

FIG. 5 is an orthogonal enlarged partial sectional view of FIG. 4.

FIG. 5A is an orthogonal exploded view of FIG. 5.

### DETAILED DESCRIPTION OF THE INVENTION

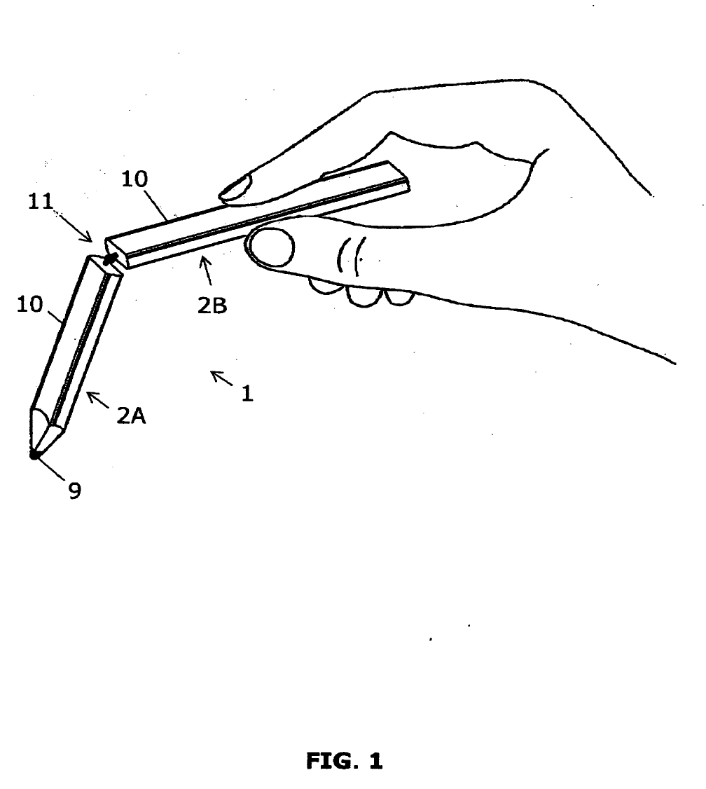

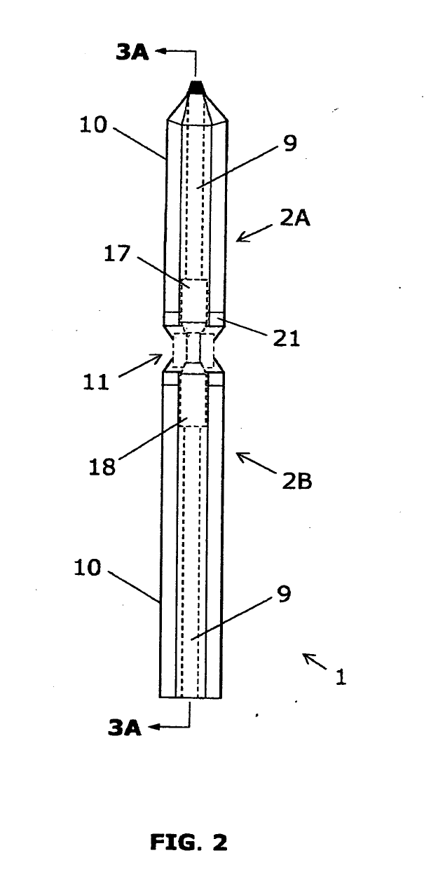

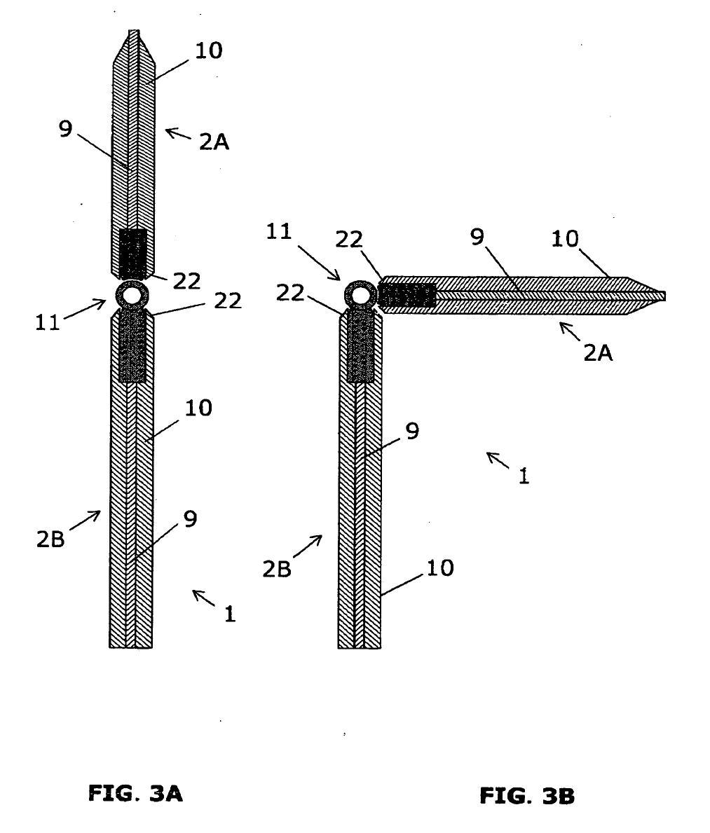

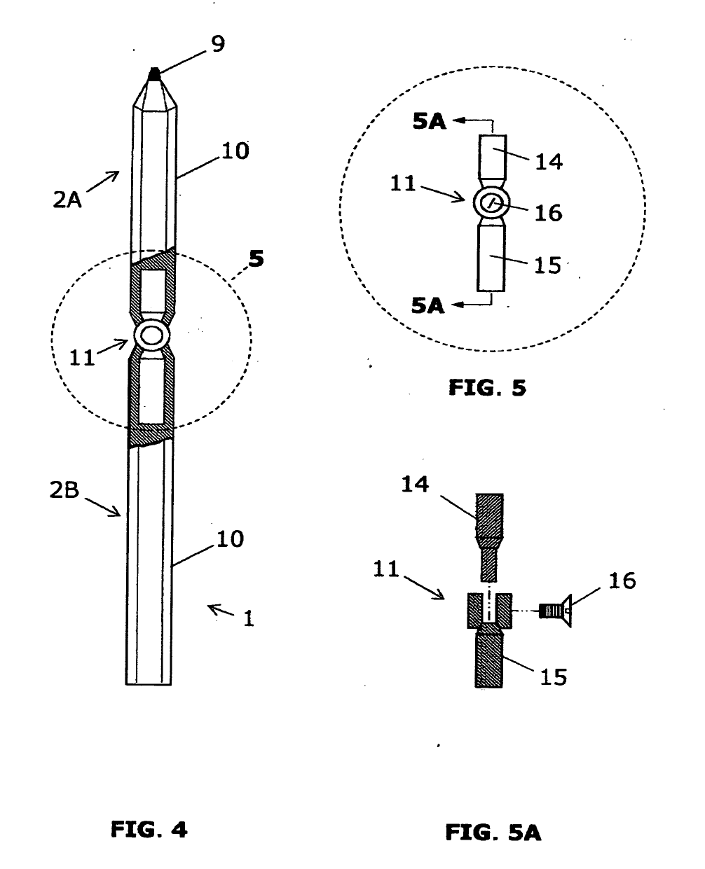

Referring to FIGS. 1 and 2, a writing instrument 1, comprising (2) matching pencil segments 2A, 2B. The pencil segments 2A, 2B, of the embodiment are comprised of an elongated core-element marking means 9, having a length of 3.5 inches, a width 0.250 of an inch, and a thickness 0.062 of an inch, and a holder 10, surrounding and encasing the elongated core-element marking means 9, and having a length of 3.5 inches, a width 0.562 of an inch, and a thickness 0.312 of an inch. A swivel joint assembly 11 connects the segments 2A, 2B, of the writing instrument 1. The swivel joint assembly 11 is made from a high strength material such as steel, but can be made from a variety of other materials as required for strength purposes. Referring to FIGS. 4, 5, 5A, the female end 15, of the swivel joint assembly 11, has a shaft 0.187 of an inch in diameter on one end and a spherical ball shape 0.250 of an inch in diameter on the opposite end. The female end 15, measures 0.688 of an inch in total length. (2) tongs are cut out on the center line of the spherical ball shaped end parallel to the length of the shaft to form a fork like shape. Each tong is 0.083 of an inch in thickness with a 0.083 of an inch space between the tongs, and a depth of 0.250 of an inch. The male end 14, of the swivel joint assembly 11, has a shaft 0.187 of an inch in diameter on one end, and a spherical ball shape 0.250 of an inch in diameter on the opposite end, and measures 1.250 inches in total length. (1) tong is cut out on the center line of the spherical ball shaped end parallel to the length of the shaft. The tong is 0.08 of an inch in thickness and 0.250 of an inch in depth. A hole is drilled through the 0.250 inch diameter spherical part of the male 14, and female 15 of the swivel joint assembly 11, perpendicular to the longitude of the shaft and center line of the 0.250 diameter sphere, and then tapped. A screw 16 is mounted in the spherical center point of the swivel joint assembly 11, swivel ably connecting the female 15, and male 14. Referring to FIGS. 1 and 2, The elongated shaft of the female end 15 and the male end 14 of the swivel joint 11 are inserted into bores 17, and 18, of segments 2A, and 2B respectively, and positioned geometrically to where the pivot axis of the swivel joint assembly 11, is perpendicular to the longitude, and parallel to the width of segments 2A, 2B, then permanently secured by a bonding agent such as glue or epoxy (not shown). Referring to FIG. 3A, which shows a sectional view of the writing instrument 1, of FIG. 2 taken at the sectioning plane, and in the direction indicated by the section arrows 3A-3A. This sectional view shows the initial position of the writing instrument 1. Referring to FIG. 3B, the subsequent view of FIG. 3A, segment 2A, in a subsequent moved position. The attached segments 2A, 2B, are tapered to a 45 degree angle 22, to prevent interference with the swivel joint assembly 11. Referring to FIGS. 1-5A, the spherical center point of the swivel joint assembly 11, pivots allowing approximately 360 degree range of free movement of attached segments 2A, 2B, The swivel joint assembly 11, is encased in a single ply of heat shrink tubing 21, 0.500 of an inch in diameter, 1.125 inches in length, and 0.0625 of all inch thick. The writing instrument 1 can be made in a variety of configurations colors, sizes, and core-element marking means 9. Users can set the writing instrument 1 at a desired angle by pivoting one or both segments 2A, 2B, in order to reach within and mark upon surfaces as needed.

### Specifications

Referring to FIGS. 1 and 2, a writing instrument 1, comprising (2) matching pencil segments 2A, 2B. The pencil segments 2A, 2B, of the embodiment are comprised of an elongated core-element marking means 9, having a length of 3.5 inches, a width 0.250 of an inch, and a thickness 0.062 of an inch, and a holder 10, surrounding and encasing the elongated core- element marking means 9, and having a length of 3.5 inches, a width 0.562 of an inch, and a thickness 0.312 of an inch. A swivel joint assembly 11 connects the segments 2A, 2B, of the writing instrument 1. The swivel joint assembly 11 is made from a high strength material such as steel, but can be made from a variety of other materials as required for strength purposes. Referring to FIGS. 4, 5, 5A, the female end 15, of the swivel joint assembly 11, has a shaft 0.187 of an inch in diameter on one end and a spherical ball shape 0.250 of an inch in diameter on the opposite end. The female end 15, measures 0.688 of an inch in total length. (2) Tongs are cut out on the center line of the spherical ball shaped end parallel to the length of the shaft to form a fork like shape. Each tong is 0.083 of an inch in thickness with a 0.083 of an inch space between the tongs, and a depth of 0.250 of an inch. The male end 14, of the swivel joint assembly 11, has a shaft 0.187 of an inch in diameter on one end, and a spherical ball shape 0.250 of an inch in diameter on the opposite end, and measures 1.250 inches in total length. (1) Tong is cut out on the center line of the spherical ball shaped end parallel to the length of the shaft. The tong is 0.08 of an inch in thickness and 0.250 of an inch in depth. A hole is drilled through the 0.250 inch diameter spherical part of the male 14, and female 15 of the swivel joint assembly 11, perpendicular to the longitude of the shaft and center line of the 0.250 diameter sphere, and then tapped. A screw 16 is mounted in the spherical center point of the swivel joint assembly 11, swivel ably connecting the female 15, and male 14. Referring to FIGS. 1 and 2, The elongated shaft of the female end 15 and the male end 14 of the swivel joint 11 are inserted into bores 17, and 18, of segments 2A, and 2B respectively, and positioned geometrically to where the pivot axis of the swivel joint assembly 11, is perpendicular to the longitude, and parallel to the width of segments 2A, 2B, then permanently secured by a bonding agent such as glue or epoxy (not shown). Referring to FIG. 3A, which shows a sectional view of the writing instrument 1, of FIG. 2 taken at the sectioning plane, and in the direction indicated by the section arrows 3A-3A. This sectional view shows the initial position of the writing instrument 1. Referring to FIG. 3B, the subsequent view of FIG. 3A, segment 2A, in a subsequent moved position. The attached segments 2A, 2B, are tapered to a 45 degree angle 22, to prevent interference with the swivel joint assembly 11. Referring to FIGS. 1-5A, the spherical center point of the swivel joint assembly 11, pivots allowing approximately 360 degree range of free movement of attached segments 2A, 2B, The swivel joint assembly 11, is encased in a single ply of heat shrink tubing 21, 0.500 of an inch in diameter, 1.125 inches in length, 0.0625 of an inch thick. The writing instrument 1 can be made in a variety of configurations colors, sizes, and core-element marking means 9. Users can set the writing instrument 1 at a desired angle by pivoting one or both segments 2A, 2B, in order to reach within and mark upon surfaces as needed.

1. A hand-held pivoting writing instrument comprising:
Segments
a) An elongated core-element means that will leave a marking line if moved across paper, wood, masonry or other similar surface, and
b) An elongated holder surrounding and encasing said elongated core element, one (1) portion of said holder being removeable from an end thereof to expose an end of said core-element means to as to enable said core-element means to be exposed for writing, whereby said holder protects said core-element means form breakage and provides and enlarged means for holding said core-element means conveniently, and
Coupling
c) An interconnecting link having an elongated shaft on one (1) end and a spherical shape on the opposite end, wherein the spherical end of the said elongated shaft is forked in shape having two (2) tongs, and
d) An interconnecting pivot having an elongated shaft on one (1) end and a spherical shape on the opposite end, wherein the spherical end of the said elongated shaft is one (1) tong having a size and shape matching the aperture of the spherical end of the said interconnecting link.

2. The elongated shaft end of the interconnecting link is attached to one (1) end of said segment.

3. The elongated shaft end of the interconnecting pivot is attached to one (1) end of said segment.

4. The interconnecting link is swivelably connected to the interconnecting pivot by a screw rotatably mounted in the interconnecting link sphere center point. The sphere center point pivots allowing free turning/movement of the attached said segments.
INVENTION BENEFITS: The “Pivot Pencil” allows users to reach into, mark within, and provide accurate markings upon space-constricted areas that would ordinarily be inaccurately marked or even bypassed from such needed markings.
The “Pivot Pencil” ensures precision in all formats of usage.
The “Pivot Pencil” can be used within constricted areas and around corners in which both conventional and industrial pencils and pens are incapable of productive use.
The “Pivot Pencil” is rigid, durable and maintains angular placement during application.
The “Pivot Pencil” can be used for and upon flooring, cabinets, woodwork, moldings, framing, roofing, drywalls, doorjambs and other objects.
The “Pivot Pencil” can be used in the trades of masonry, construction, designing, architecture, engineering and even hobbies.
The “Pivot Pencil” can improve the production time as well as the production accuracy in all such arenas of usage.
The “Pivot Pencil” can provide these benefits to industrial, home and office users.
The “Pivot Pencil” can make all such uses in all such arenas by all such users much easier to complete, faster to complete and with needed accuracy.
INVENTION VARIATIONS: The “Pivot Pencil” can be made in various total lengths.
The barrel of the “Pivot Pencil” can be produced in various colors and with various imprint designs, including but not limited to the name and/or logo of its manufacturing company, its product name and/or logo, and/or an English and/or metric measurement ruler marking.
The “Pivot Pencil” can be produced in various shaped formats, including but not limited to various octagonal, elliptical, square and hexagonal designs. In each of such variation formats, various total widths, plane widths, total heights and plane heights can be used.
The swivel joint of the “Pivot Pencil” can be made of various applicable substances, including but not limited to alloy steel, aluminum alloy, carbon steel, leaded steel and stainless steel.
The swivel joint of the “Pivot Pencil” may or may not be coated, and various substances may be used to provide such coating, including but not limited to various rubbers and/or plastics of intended applicability.
The swivel joint of the “Pivot Pencil” may be capable of producing a wide angle range of various degrees, and may or may not include a measuring gauge to determine the exact angle degree in use.
The swivel joint of the “Pivot Pencil” may be fitted permanently into both pencil ends, may attach to both pencil ends by rod insertion into the pencil wood/lead, and/or may use attachment of the pencil ends by insertion into fitted sleeves extending from the swivel joint. In the latter two (2) formats, the swivel joint may be reusable with other pencil attachment pieces.
The “Pencil Pivot” can be made in separate varieties using hard, medium and soft leads, and these leads may be produced in various colors. The “Pivot Pencil” can also be produced in variations using replaceable-carded lead.
The “Pivot Pencil” can be made in variations for other industrial uses, including but not limited to china marker and/or lumber crayon The “Pivot Pencil” can also be produced in standard pencil formats for no particular industrial use.
The “Pivot Pencil” can be made in variation of a two-(2) pencil-point compass, and this compass format may be of various applicable materials, producing various maximum diameters, and may be made with various types of pencil locks.
MECHANICAL DESCRIPTION: The pencil portions of the “Pivot Pencil” consist of two (2) wooden pencils in matching flat-octagonal columnar designs, and have total measurement of seven-and-three-sixteenths inches in length by nine-sixteenths-of-one-inch in width by five-sixteenths-of-one-inch in height (7 3/16″× 9/16″× 5/16″) when attached.
The hard graphite leads within the wooden pencils have rectangular columnar designs and total measurement of approximately seven-and-three-sixteenths inches in length by one-fourth-of-one-inch in width by one-sixteenth-of-one-inch in height (7 3/16″×¼″× 1/16′).
The swivel joint that connects the two (2) pencil portions is made of an alloy steel material, and measures one-and-three-quarter-inches (1¾″) in total length. The female end of this swivel joint has a length of eleven-sixteenths-of-one-inch ( 11/16″), its male end measures one-and-one-fourth-of-one-inch (¼″), and the outside end of this swivel shaft measures three-sixteenths-of-one-inch ( 3/16″).
This swivel joint fits into a truss head slot of 6-32 by one-fourth-of-one-inch variety (6-32×¼″) found within the pencil portion. At the swivel joint connecting points of each pencil end, the pencil portions are tapered to forty-five degree (45°) angles to avoid interfacing contact with the swivel joint allowing for full angular adjustment.
The swivel joint is encased in a single-ply of heat-shrunk ethylene propylene diene monomer (EPDM) of one-eight-of-one-inch by one-sixteenth-of-one-inch (⅛″× 1/16″) dimension.
USAGE: Users can set the “Pivot Pencil” at a desired angle by bending its swivel joint in order to reach within and mark upon surfaces as needed.
